(19) United States
(12) Patent Application Publication
(10) Pub. No.: US 2008/0160416 A1
(43) Pub. Date: Jul. 3, 2008

(54) Phosphide composite material and anode material of lithium ion cell

(76) Inventors: Li-Jiun Chen, Hsinchu City (TW); Zheng-Zhao Guo, Jhonghe City (TW); Mo-Hua Yang, Hsinchu City (TW)

Correspondence Address: J.C. Patents;Suite 250, 4 Venture, Irvine, CA, 92618, US

(21) Appl. No.: 11/998,195

(22) Filed: Nov. 28, 2007

(30) Foreign Application Priority Data
Dec. 27, 2006 (TW) 95149230

(51) Int. Cl. H01M 4/58; B32B 5/16

(52) U.S. Cl. 429/231.8; 429/218.1; 428/403

(57) ABSTRACT

A phosphide composite material including at least primary particles is disclosed. The primary particles include a transition metal phosphide and a coating layer covering the transition metal phosphide. The capacity of the phosphide composite material is higher than carbon, and the structural thereof is better than the transition metal phosphide. Thus, the phosphide composite material is suitable for serving as anode material of lithium ion cell.

### CROSS-REFERENCE TO RELATED APPLICATION

This application claims the priority benefit of Taiwan application serial no. 95149230, filed Dec. 27, 2006. All disclosure of the Taiwan application is incorporated herein by reference.

### BACKGROUND OF THE INVENTION

1. Field of the Invention

The present invention relates to a phosphide composite material.

2. Description of Related Art

The lithium ion cell is applied or proposed to be applied in high-power power systems. Besides further improvements in cell design and the cell fabrication technique, the specification requirements on the cell material is also required. Among the cell materials, the improvement of electrode materials is highly demanded. Therefore, the key technical issue to be resolved in the next stage is the development of the anode material, especially the development of the lithium ion storage capacity of the anode material and the structural stability. Currently, the widely used commercial cell anode material is carbon having a capacity of about 200-350 mAh/g (soft carbon, 200-240 mAh/g or MCMB graphite, 300-340 mAh/g). The conventional graphite carbon material has the disadvantage that carbon is likely to react with electrolyte including polycarbonate to form a passivation film on the surface of the carbon or graphite leading to an irreversible loss of capacity, resulting in low first charge-discharge efficiency or shortening the service of the cell. Thus, for storage system and high energy density cell, further improvement in the capacity of the anode material is required.

Besides carbon, examples of other anode material includes (1) alloys, such as SnSb and SnCo; (2) oxides of A group elements, such as SiOx and SnOx the oxides of Si and Sn; (3) oxides of transition metals, such as CoO; and (4) nitrides of transition metal. The goal of the major research in the field of the anode material of lithium cell is to obtain a material having 1. a higher energy density and 2. a better storage capability, and 3. a high ratio of capacity during first charge-discharge process [ratio:reversible capacity divided by total capacity]. Furthermore, it is also desired that such material can be obtained by a simple process.

It is verified by researchers that, transition metal phosphide, such as FeP₂, CoP₃ and MnP₄, has a high capacity. For example, it was found by Nazar et al. that the capacity of FeP₂ is 1250 mAh/g. However, after less than ten cycles of charge/discharge, the capacity is degraded and cannot be reused. Though the de-intercalation and intercalation mechanism of lithium ion is similar to the storage mechanism of lithium oxide, the exact mechanism is not completely known. Therefore, it is deduced that the main cause of the material degeneration lies in the volume expansion caused by the lithium ion intercalation, which leads to the collapse of the material structure after multiple charge/discharge cycles; Additionally, it was set forth by Doublet et al. that an irreversible reaction may generated on the material surface when the phosphide, such as FeP₁, is reacted with the electrolyte of current lithium cell system. Therefore, though transition metal phosphide has high capacity, it cannot be applied as the anode material of lithium ion cell at present.

### SUMMARY OF THE INVENTION

Accordingly, the present invention is directed to a phosphide composite material having a higher capacity compared to carbon and a better structural stability compared to the transition metal phosphide, and can be applied as the anode material of lithium ion cell, so as to obtain a high performance anode.

The present invention is directed to a phosphide composite material including at least primary particles including a transition metal phosphide and a coating layer covering the transition metal phosphide.

The present invention is directed to a lithium ion cell including a phosphide composite material as an anode material.

The present invention is also directed to a lithium ion cell including a mixture of phosphide composite material and MCMB graphite as an anode material.

It can be seen from the above description, by the coating layer, the phosphide composite material according to the present invention can control the volume expansion generated during the reaction of the primary particles and the lithium ions. Moreover, the primary particles of the present invention can further improve the ability of controlling the volume expansion of the composite material of phosphide by a nano-scale size less than 100 nm. Therefore, the phosphide composite material of the present invention may be suitable for serving as an anode material of lithium ion cell.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of principal constituent elements of a phosphide composite material according to an embodiment of the present invention.

FIG. 2 is a schematic view of a powdery structure of the phosphide composite material according to an embodiment of the present invention.

FIG. 3 is an electron micrograph of the powdery structure of a carbon-coated iron phosphide.

FIG. 4 is a schematic view of test results of cyclic voltammetry of the carbon-coated iron phosphide material.

FIG. 5 is a schematic view of test results of the capacity of the carbon-coated iron phosphide material.

FIG. 6 is a schematic view of test results of the cycling life of the carbon-coated iron phosphide material.

### DESCRIPTION OF EMBODIMENTS

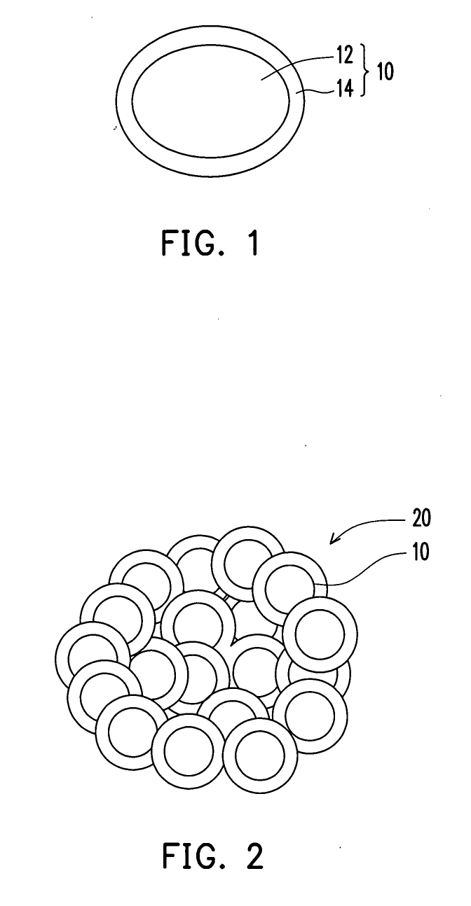

FIG. 1 is a schematic view of principal constituent elements of a phosphide composite material according to an embodiment of the present invention. Referring to FIG. 1, the phosphide composite material of the present invention at least includes primary particles 10 including at least a transition metal phosphide 12 and a coating layer 14 covering the transition metal phosphide 12. The transition metal phosphide 12 is used to store lithium ions by reacting the phosphorus ion and lithium ions. Examples of the transition metal in the transition metal phosphide 12 includes, for example but not limited to, iron, cobalt, nickel, copper, zinc, manganese, chromium, vanadium, titanium, or scandium. The coating layer 14 comprises, for example but not limited to, a material that allows the lithium ion to pass through. The coating layer 14 comprises, for example but not limited to, carbon, while considering the compatibility of the current electrolyte. The particle size of the primary particles 10 is, for example, less than 100 nm.

Additionally, some other elements can optionally be doped in the composite material of phosphide of the present invention to adjust the electrochemical properties. For example, in one embodiment of the present invention, trace of tin is doped in the composite material of phosphide of the present invention.

The phosphide composite material of the present invention may be in a powder form. FIG. 2 is a schematic view of the powdery structure of the phosphide composite material according to the present invention. As shown in FIG. 2, the powder of the phosphide composite material is mainly consistuted by secondary particle 20 formed by aggregation of the primary particles 10. The particle size of the secondary particles 20 is, for example, less than 20 μm.

It is notable that, in the phosphide composite material of the present invention, as the primary particles 10 are composed by the transition metal phosphide 12 and the coating layer 14 covering the transition metal phosphide 12. According to an embodiment of the present invention, the coating layer 14 covering the primary particles 10 may control the volume expansion generated during the reaction of the primary particles 10 and lithium ions.

Furthermore, as the particle size of the primary particles 10 is in a nano-scale range of less than 100 nm, the ability of controlling the volume expansion of the phosphide composite material can be further improved so as to achieve a better structural stability compared to the conventional transition metal phosphide.

To sum up, the phosphide composite material has the advantages of a higher capacity compared to the conventional carbon when applied in an anode material of lithium ion cell due to the advantageous properties of the transition metal phosphide. Moreover, as discussed above, the capability of controlling the volume expansion would greatly increase the structural stability thereof, which is advantageous to achieve a better cyclic charge/discharge ability.

### Embodiments

### [Preparation of Phosphide Composite Material]

First, a nano-size iron phosphide (FeP) precursor is prepared by iron ion/phosphoric acid/polyacrylic acid (PAC) precipitation process. Meanwhile, a dopant material, such as Sn, is added in the precipitation process. Then, the FeP precursor is calcined over 800° C. for 20 hours in H₂/Ar flow. After the calcining process, a carbon-coated nano-size iron phosphide structure was formed. The carbon-coated iron phosphide prepared by the preparation method is analyzed to have a iron phosphide structure of Fe₁P_{(0.898˜1.17)}, carbon-coated layer of 8.5-11.5 wt %, and an amount of doped tin of less than 3 wt %.

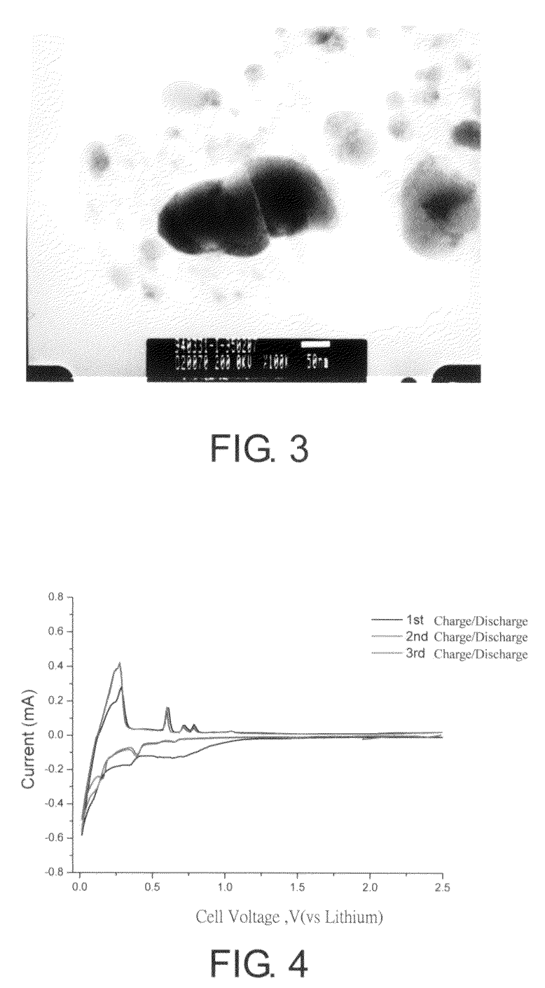

FIG. 3 is an electron micrograph of the powdery structure of a carbon-coated iron phosphide. As shown in FIG. 3, the powdery structure of the iron phophide actually is the secondary particles composed of the primary particles, in which the particle size of the primary particles is in a range of about 20-50 nm. As shown in FIG. 3, the primary particles are formed by coating a carbon network on the external of the iron phosphide to form a carbon-coated layer covering the iron phosphide completely. Thus, from the electron micrograph of FIG. 3, it can be confirmed that the carbon-coated nano iron phosphide powder prepared according to the above method is a phosphide composite material including the advantageous features of the present invention.

### Test of Electrochemical Properties

The electrochemical properties of the carbon-coated iron phosphide powder prepared by the above process of the present invention is evaluated by using a Wt./Wt. ratio of 1:1 mixture of commercial MCMB graphite and carbon-coated iron phosphide powder.

FIG. 4 is a schematic view of test results of cyclic voltammetry (CV) of the carbon-coated iron phosphide material. The electrochemical reaction potential during the intercalation of lithium ions into the iron phosphide material can be known from the test. As shown in FIG. 4, for the carbon-coated iron phosphide material, a reducing reaction began at about 1.0 V in the test, which can be deduced to be related to the reaction between the electrolyte and the material surface. After the potential has reached 0.4 V, an obvious reducing reaction occurred. By comparing with the test results after the second cycle, it can be deduced that the reaction potential is the reaction potential when the lithium ions immigrating into the iron phosphide. While the oxidation potential of 0.6 V corresponds to the reaction of the de-intercalation of lithium out of the iron phosphide. After the second cycle, it can be observed that the current strength of the intercalation and de-intercalation reaction potential is mostly uncharged. It can be deduced that because the carbon is coated on the iron phosphide material, therefore the surface reaction and the structure of carbon-coated iron phosphide material are stable. Accordingly, it can be further deduced that the intercalation and de-intercalation behaviors are considerably stable electrochemical reactions.

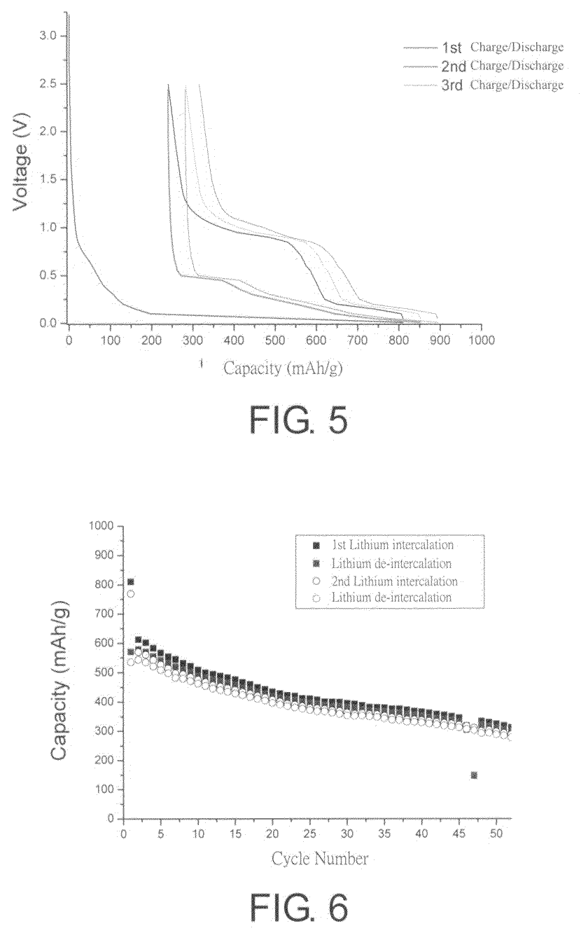

FIG. 5 is a schematic view of test results of the capacity of the carbon-coated iron phosphide material. As shown in FIG. 5, it can be observed from the current-voltage graph that, at the test of the second cycle, a charge platform exists at 0.5 V, and a corresponding discharge platform exists at about 1.0 V. With the increment of the charge/discharge cycles, the charge/discharge capacity of the platform is not reduced obviously. Therefore, the carbon-coated iron phosphide material of the present invention has a better structural stability. Additionally, it can be found from the result that the charge capacity of the carbon-coated iron phosphide material at the first cycle is about 800 mAh/g, and the reversible capacity is about 550 mAh/g.

FIG. 6 is a schematic view of test results of cycling life of the carbon-coated iron phosphide material. As shown in FIG. 6, at the test of the twentieth cycle, the carbon-coated iron phosphide of the present invention still has a capacity of 400 mAh/g, and according to the test results reported by references (FeP₂), the capacity of the iron phosphide material after ten cycles is degenerated from 1200 mAh to a stage at which the iron phosphide material fails to be charged and discharged. Thus, the carbon-coated iron phosphide material of the present invention has a better structural stability.

As can be known from the test results of the electrochemical properties, the electrode material prepared by a weight ratio of 1:1 of the carbon-coated iron phosphide material of the present invention and the MCMB graphite has a greater applicability as the anode material of lithium ion cell.

In view of the above, as the primary particles of the phosphide composite material of the present invention is composed of a transition metal phosphide and a coating layer covering the transition metal phosphide, therefore the volume expansion generated during the reaction of the primary particles and the lithium ions may be controlled by the coating layer.

Moreover, as the primary particles of the phosphide composite material has a nano-scale size of less than 100 nm, the ability of controlling the volume expansion thereof can be further improved.

Accordingly, the phosphide composite material of the present invention has a higher capacity and higher structural stability compared with the conventional transition metal phosphide, and therefore has considerably high development potential and may be practically applied as the anode material of lithium ion cell.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A phosphide composite material, at least comprising:
primary particles comprising a transition metal phosphide and a coating layer covering the transition metal phosphide.

2. The phosphide composite material as claimed in claim 1, wherein transition metal used in the transition metal phosphide comprisesiron, cobalt, nickel, copper, zinc, manganese, chromium, vanadium, titanium or scandium.

3. The phosphide composite material as claimed in claim 1, wherein the coating layer is a material allows lithium ion to pass through.

4. The phosphide composite material as claimed in claim 1, wherein the coating layer comprises carbon.

5. The phosphide composite material as claimed in claim 1, wherein the primary particles have a particle size of less than 100 nm.

6. The phosphide composite material as claimed in claim 1, wherein the primary particles form secondary particles, and the secondary particles constitute powders of the phosphide composite material.

7. The phosphide composite material as claimed in claim 6, wherein the secondary particles have a particle size less than 20 μm.

8. An anode material of lithium ion cell, using the phosphide composite material as claimed in claim 1 as an anode material of lithium ion cell.

9. An anode material of lithium ion cell, using a mixture of the phosphide composite material as claimed in claim 1 and MCMB graphite as an anode material of lithium ion cell.

10. The anode material of lithium ion cell as claimed in claim 9, wherein the mixing ratio of the composite material of phosphide and the MCMB graphite is 1:1 by weight.
